(19) United States
(12) Patent Application Publication
(10) Pub. No.: US 2024/0412931 A1
(43) Pub. Date: Dec. 12, 2024

(54) ELECTRIC CIRCUIT BREAKER DEVICE

(71) Applicant: DAICEL CORPORATION, Osaka-shi, Osaka (JP)

(72) Inventor: Yuichiro KAWANAKA, Tokyo (JP)

(73) Assignee: DAICEL CORPORATION, Osaka-shi, Osaka (JP)

(21) Appl. No.: 18/700,909

(22) PCT Filed: Sep. 14, 2022
(86) PCT No.: PCT/JP2022/034399

§ 371 Date: Apr. 12, 2024

(30) Foreign Application Priority Data
Oct. 14, 2021 (JP) 2021-168885

(51) Int. Cl. H01H 39/00; H01H 71/02

(52) U.S. Cl. CPC H01H 39/006; H01H 71/025; H01H 2071/0292

(57) ABSTRACT

An electric circuit breaker device includes a housing enclosing an accommodating space, an igniter, and a conductor piece. The housing includes a housing body that holds the conductor piece and a top housing portion provided with the igniter. The top housing portion forms, by the top housing portion being attached to a first surface of the housing body, an internal space communicating with the accommodating space and forming an end of the accommodating space, and includes a peripheral wall that defines an outer periphery of the accommodating space and is provided along the extending direction of the accommodating space, a top-side flange portion extended from a contact portion of the peripheral wall with the first surface toward an outer side of the top housing portion along the first surface, and a rib portion extended along the extending direction from an outer side edge of the top-side flange portion.

### TECHNICAL FIELD

The present invention relates to an electric circuit breaker device.

### BACKGROUND ART

An electric circuit may be provided with a breaker device that is actuated when an abnormality occurs in a device constituting the electric circuit or when an abnormality occurs in a system in which the electric circuit is mounted, thereby urgently interrupting the continuity of the electric circuit. As one aspect thereof, there has been proposed an electric circuit breaker device that forcibly and physically cuts a conductor piece forming a portion of an electric circuit by moving a projectile at high speed by energy applied from an igniter or the like (see, for example, Patent Document 1). Further, in recent years, electric circuit breaker devices applied to electric vehicles equipped with a high-voltage power source are becoming increasingly important.

### CITATION LIST

### Patent Document

Patent Document 1: WO 2020/099546
Patent Document 2: JP 4985871 B

### SUMMARY OF INVENTION

### Technical Problem

The electric circuit breaker device includes, for example, as an outer shell member, a housing enclosing an accommodating space extending in one direction, an igniter provided in the housing, a projectile that is projected from one end side of the accommodating space by energy received from the igniter and moves along the extending direction of the accommodating space, and a conductor piece that is disposed crossing the space and is cut by the projectile. The housing includes a housing body that holds the conductor piece and an igniter-side housing portion provided with the igniter. The igniter-side housing portion is attached with it being in contact with a first surface of the housing body. The igniter-side housing portion includes an internal space communicating with the accommodating space in the housing body and forming one end on the igniter side of the accommodating space, and also includes a peripheral wall defining an outer periphery of the accommodating space and provided along the extending direction of the accommodating space, and a flange portion extending from a contact portion of the peripheral wall with the first surface toward an outer side of the igniter-side housing portion along the first surface.

In the electric circuit breaker device having the above configuration, when a high-pressure gas is generated by ignition of the igniter and the projectile is projected by this energy, the flange portion may be distorted by the pressure at the time of ignition. When the flange portion is distorted, there arises a possibility that a gap is formed between the flange portion and the housing body to leak the high-pressure gas. Thus, it has been desired to improve the reliability of the electric circuit breaker device by suppressing the distortion of the flange portion at the time of ignition to prevent the leakage of the high-pressure gas.

An object of the technique of the present disclosure is to provide a technique for improving the reliability of an electric circuit breaker device.

### Solution to Problem

To solve the above-mentioned problems, an electric circuit breaker device according to an embodiment of the present disclosure includes:
a housing, as an outer shell member, that encloses an accommodating space extending in one direction;
an igniter provided in the housing;
a projectile disposed in the housing and being configured to be projected from one end side of the accommodating space by energy received from the igniter and move along an extending direction of the accommodating space; and
a conductor piece provided in the housing and forming a portion of an electric circuit, the conductor piece including, in part of the conductor piece, a cutoff portion that is disposed crossing the accommodating space and is to be cut off by the projectile.

In the electric circuit breaker device,
the housing includes a housing body that holds the conductor piece and a top housing portion provided with the igniter,
the housing body includes the accommodating space passing through the housing body from a first surface on a side of the igniter to a second surface located on a side opposite to the first surface,
the top housing portion forms, by the top housing portion being attached while being in contact with the first surface of the housing body, an internal space communicating with the accommodating space inside the housing body and forming a portion of the accommodating space that accommodates the projectile before being projected, and
the top housing portion includes
a peripheral wall that defines an outer periphery of the accommodating space and is provided along the extending direction of the accommodating space,
a top-side flange portion extended from a contact portion of the peripheral wall with the first surface toward an outer side of the top housing portion along the first surface, and
a top-side rib portion extended along the extending direction from an outer side edge of the top-side flange portion.

In the electric circuit breaker device, the top-side rib portion may be extended from the outer side edge of the top-side flange portion toward a side of the conductor piece along the extending direction.

In the electric circuit breaker device, the top-side rib portion may be extended from the outer side edge of the top-side flange portion toward a side of the conductor piece along the extending direction.

In the electric circuit breaker device, the top-side rib portion may be extended from the outer side edge of the top-side flange portion toward a side opposite to the conductor piece along the extending direction.

In the electric circuit breaker device,
the housing may further include a bottom housing portion being attached while being in contact with the second surface, and including an internal space that communicates with the accommodating space inside the housing body and forms a portion of the accommodating space in which the cutoff portion is to be received after being cut off, and
the bottom housing portion may include
a peripheral wall that defines an outer periphery of the accommodating space and is provided along the extending direction of the accommodating space,
a bottom-side flange portion extended from a contact portion of the peripheral wall with the second surface toward an outer side of the bottom housing portion along the second surface, and
a bottom-side rib portion extended from an outer side edge of the bottom housing portion toward the side of the conductor piece along the extending direction.

In the electric circuit breaker device, the second surface of the housing body is provided with a groove portion into which the bottom-side rib portion of the bottom housing portion is fitted.

In the aforementioned electric circuit breaker device,
the housing may further include a bottom housing portion being attached while being in contact with the second surface, and including an internal space that communicates with the accommodating space inside the housing body and forms a portion of the accommodating space in which the cutoff portion is to be received after being cut off, and
the bottom housing portion may include
a peripheral wall that defines an outer periphery of the accommodating space and is provided along the extending direction of the accommodating space,
a bottom-side flange portion extended from a contact portion of the peripheral wall with the second surface toward an outer side of the bottom housing portion along the second surface, and
a bottom-side rib portion extended from an outer side edge of the bottom housing portion toward the side of the conductor piece along the extending direction.

### Advantageous Effects of Invention

According to an embodiment of the present disclosure, a technique for improving the reliability of an electric circuit breaker device may be provided.

### BRIEF DESCRIPTION OF DRAWINGS

FIG. 1 is a diagram illustrating an internal structure of an electric circuit breaker device (hereinafter simply referred to as a “breaker device”) 1 according to an embodiment.

FIG. 2 is a cross-sectional view taken along line A-A illustrated in FIG. 1.

FIG. 3 is a top view of an upper housing body.

FIG. 4 is a vertical cross-sectional view of the upper housing body taken along line B-B illustrated in FIG. 3.

FIG. 5 is a bottom view of a lower housing body.

FIG. 6 is a vertical cross-sectional view of the lower housing body taken along line C-C illustrated in FIG. 5.

FIG. 7 is a bottom view of a top holder.

FIG. 8 is a vertical cross-sectional view of the top holder taken along line D-D illustrated in FIG. 7.

FIG. 9 is a top view of a bottom container.

FIG. 10 is a vertical cross-sectional view of the bottom container taken along line E-E illustrated in FIG. 9.

FIG. 11 is a diagram illustrating an actuation situation of a breaker device according to the embodiment.

FIG. 12 is a diagram illustrating a variation of a rib portion.

### DESCRIPTION OF EMBODIMENTS

### First Embodiment

An electric circuit breaker device according to an embodiment of the present disclosure will be described below with reference to the drawings. Note that each of the configurations, combinations thereof, and the like in an embodiment is an example, and various additions, omissions, substitutions, and other changes may be made as appropriate without departing from the spirit of the present disclosure. The present disclosure is not limited by an embodiment and is limited only by the claims.

### Configuration

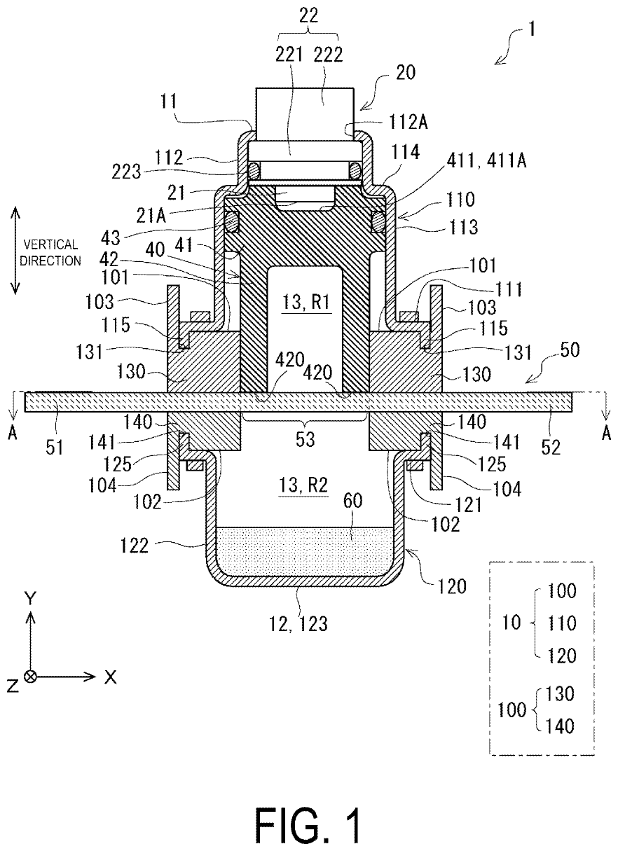

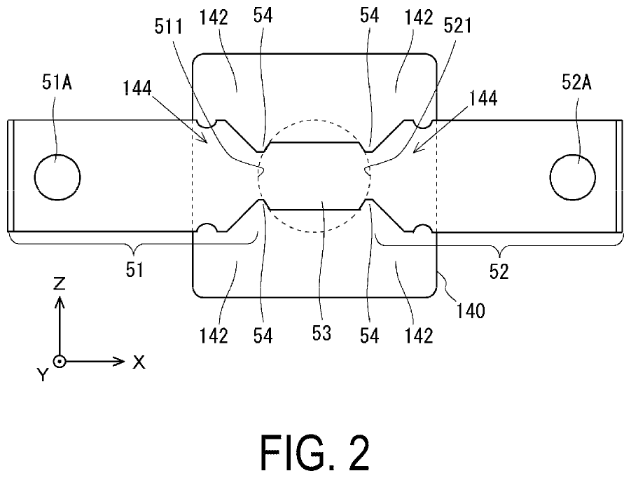

FIG. 1 is a diagram illustrating an internal structure of an electric circuit breaker device (hereinafter, simply referred to as a “breaker device”) 1 according to an embodiment, and FIG. 2 is a cross-sectional view taken along line A-A illustrated in FIG. 1. The breaker device 1 is a device that interrupts an electric circuit included in a vehicle, an electric home appliance, a photovoltaic system, or the like when an abnormality occurs in the electric circuit or in a system including a battery (lithium-ion battery, for example) of the electric circuit, thereby preventing great damage. In the present specification, a cross section in the height direction illustrated in FIG. 1 (direction in which an accommodating space 13 described later extends) is referred to as a vertical cross section of the breaker device 1, and a cross section in a direction orthogonal to the height direction is referred to as a transverse cross section of the breaker device 1. FIG. 1 illustrates a state prior to actuation of the breaker device 1.

The breaker device 1 includes a housing 10, an igniter 20, a projectile 40, a conductor piece 50, and coolant material 60. The housing 10, as an outer shell member, encloses an accommodating space 13 extending in a direction from a first end portion 11 on an upper end side toward a second end portion 12 on a lower end side. This accommodating space 13 is a space formed linearly, making the projectile 40 movable, and extends along a vertical direction of the breaker device 1. As illustrated in FIG. 1, the projectile 40 is accommodated on the upper end side in the vertical direction (extending direction) of the accommodating space 13 formed inside the housing 10. In the present specification, the vertical direction is also referred to as a Y-axis direction, the left-right direction is also referred to as an X-axis direction, and the depth direction is also referred to as a Z-axis direction. However, in the present specification, the vertical direction and the XYZ directions of the breaker device 1 merely indicate a relative positional relationship of elements in the breaker device 1 for convenience of description of an embodiment. For example, the orientation at the time of installing the breaker device 1 is not limited to the direction illustrated in the drawing.

### Housing

The housing 10 includes a housing body 100, a top holder (top housing portion) 110, and a bottom container (bottom housing portion) 120. The top holder 110 and the bottom container 120 are bonded to the housing body 100, thereby forming the housing 10 that is integrated.

The housing body 100 is divided in the vertical direction with the position where the conductor piece 50 is disposed as a boundary, and includes an upper housing body 130 in an upper portion and a lower housing body 140 in a lower portion. In the present embodiment, the upper side of the housing 10 including this upper housing body 130 and the top holder 110 is also referred to as a first housing, and the lower side of the housing 10 including the lower housing body 140 and the bottom container 120 is also referred to as a second housing. Note that the housing body is not limited to the divided configuration, and may be integrally formed from the upper end connected to the top holder 110 to the lower end connected to the bottom container 120.

The housing body 100 in a state where the upper housing body 130 and the lower housing body 140 are combined has, for example, a substantially rectangular columnar outer shape. However, the shape of the housing body 100 is not particularly limited. The housing body 100 includes a cavity portion formed therethrough along the vertical direction. This cavity portion forms a portion of the accommodating space 13. Furthermore, the housing body 100 includes an upper surface (first surface) 101, to which a flange portion (top-side flange portion) 111 of the top holder 110 is fixed, and a lower surface (second surface) 102, to which a flange portion (bottom-side flange portion) 121 of the bottom container 120 is fixed. An upper tubular wall 103 having a tubular shape is provided erected upward from the upper surface 101 on the outer circumferential side of the upper surface 101 in the housing body 100. In the present embodiment, the upper tubular wall 103 has a rectangular tubular shape, for example, but may have other shapes. On the outer circumferential side of the lower surface 102 in the housing body 100, a lower tubular wall 104 having a tubular shape is provided suspended downward from the lower surface 102. In the present embodiment, the lower tubular wall 104 has a rectangular tubular shape, for example, but may have other shapes.

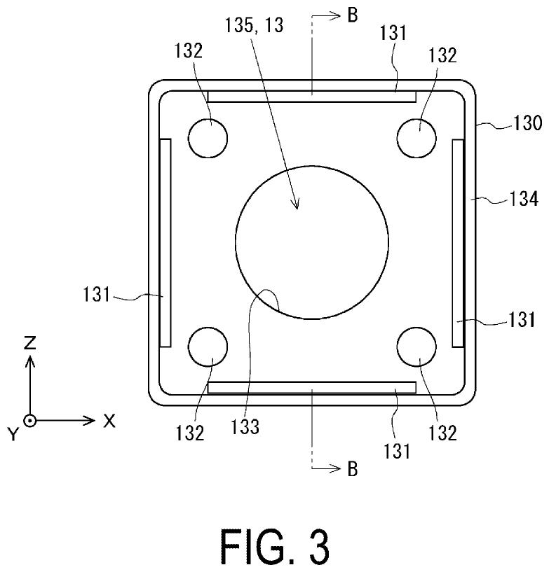

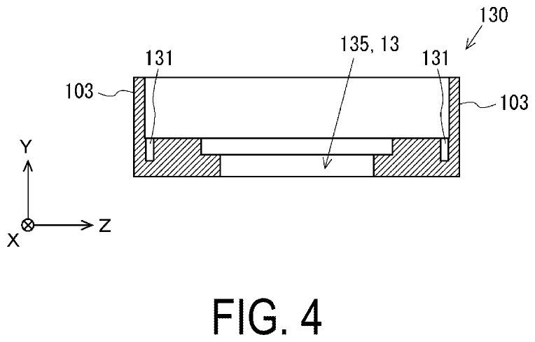

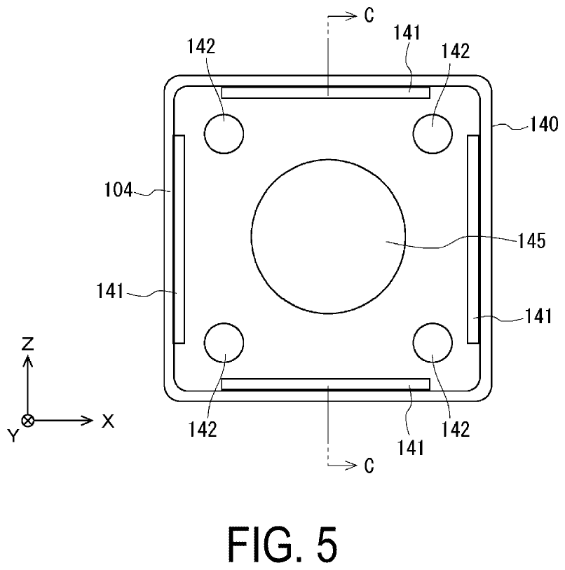

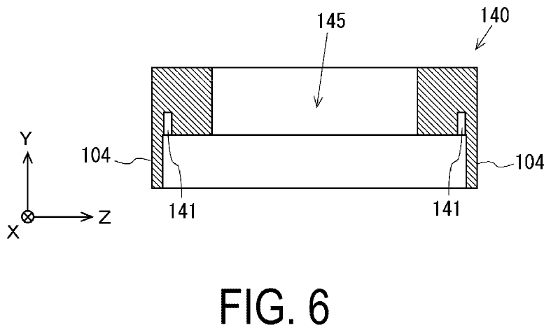

FIG. 3 is a top view of the upper housing body 130, FIG. 4 is a vertical cross-sectional view of the upper housing body 130 taken along line B-B illustrated in FIG. 3, FIG. 5 is a bottom view of the lower housing body 140, and FIG. 6 is a vertical cross-sectional view of the lower housing body 140 taken along line C-C illustrated in FIG. 5.

As illustrated in FIG. 3, the upper housing body 130 has a substantially quadrangular outer shape in a plan view, and a cavity portion 135 is provided at the center thereof. This cavity portion 135 forms a portion of the accommodating space 13 when the upper housing body 130 is combined with another member included in the housing 10. A groove portion 131, into which a rib portion (top-side rib portion) 115 of the top holder 110 is fitted, is provided on an inner side of the upper tubular wall 103 on the upper surface 101 of the upper housing body 130. The groove portion 131 is formed such that the width thereof in a direction (the Z direction or the X direction in the example of FIG. 3) orthogonal to the extending direction (the Y direction) of the accommodating space 13 is substantially equal to the thickness of the rib portion 115. As illustrated in FIG. 4, the groove portion 131 is formed as a bottomed groove provided along the Y direction from the upper surface 101 of the upper housing body 130, and is formed such that the depth thereof is equal to or larger than the length in the Y direction of the rib portion 115.

As illustrated in FIG. 5, the lower housing body 140 has a substantially quadrangular outer shape in a plan view, and a cavity portion 145 is provided at the center thereof. This cavity portion 145 forms a portion of the accommodating space 13 when the lower housing body 140 is combined with another member included in the housing 10. On an outer edge portion of the lower surface 102 of the lower housing body 140, the lower tubular wall 104 having a rectangular tubular shape is provided suspended downward from the lower surface. A groove portion 141, into which a rib portion (bottom-side rib portion) 125 of the bottom container 120 is fitted, is provided on an inner side of the lower tubular wall 104 on the lower surface 102 of the lower housing body 140. The groove portion 141 is formed such that the width thereof in a direction (the Z direction or the X direction in the example of FIG. 5) orthogonal to the extending direction (the Y direction) of the accommodating space 13 is substantially equal to the thickness of the rib portion 115. As illustrated in FIG. 6, the groove portion 131 is formed as a bottomed groove provided along the Y direction from the lower surface 102 of the lower housing body 140, and is formed such that the depth thereof is equal to or larger than the length in the Y direction of the rib portion 125.

### Top Holder

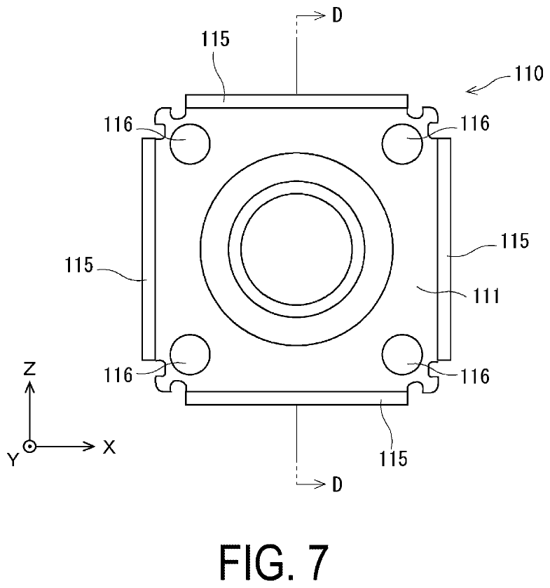

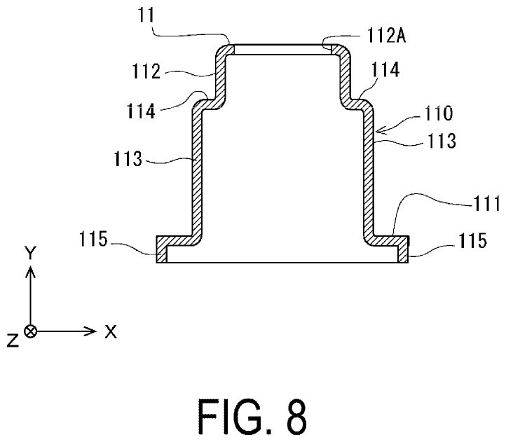

Next, the top holder 110 will be described. FIG. 7 is a bottom view of the top holder 110, and FIG. 8 is a vertical cross-sectional view of the top holder 110 taken along line D-D illustrated in FIG. 7. The top holder 110 is, for example, a cylindrical member having a stepped cylindrical tubular shape with a hollow inside. The top holder 110 includes a small diameter cylinder portion 112 located on the upper side, a large diameter cylinder portion 113 located on the lower side, a connection portion 114 connecting these cylinder portions, and the flange portion 111 extending outward from a lower end of the large diameter cylinder portion (peripheral wall) 113, that is, from a contact portion with the upper housing body 130. For example, the small diameter cylinder portion 112 and the large diameter cylinder portion 113 are coaxially disposed, and the large diameter cylinder portion 113 has a diameter slightly larger than that of the small diameter cylinder portion 112.

The contour of the flange portion 111 in the top holder 110 has a substantially quadrangular shape that fits inside the upper tubular wall 103 in the housing body 100. A bolt passing hole 116 is provided passing through the flange portion 111 in the vertical direction. A fastening bolt is made to pass through the bolt passing hole 116. The four edges of the flange portion 111 are each provided with the rib portion 115 extended toward the conductor piece 50 side along the extending direction (Y direction) of the accommodating space. The rib portion 115 has a flat plate shape formed longitudinally along the outer edge of the flange portion 111. The rib portion 115 can be formed by bending each of the four sides of the flange portion 111 downward. The size of the rib portion 115 is not particularly limited. For example, the length thereof along an outer side of the flange portion 111 (hereinafter also referred to as a “rib length”) may be 10 mm to 30 mm, and the length thereof protruding downward from the lower surface of the flange portion 111 (hereinafter also referred to as a “rib height”) may be 1 mm to 10 mm.

The cavity portion formed inside the small diameter cylinder portion 112 in the top holder 110 functions as an accommodating space for accommodating a portion of the igniter 20 as illustrated in FIG. 1. The cavity portion (internal space) formed inside the large diameter cylinder portion 113 in the top holder 110 communicates with the cavity portion of the housing body 100 located on the lower side, and forms a portion of the accommodating space 13. The top holder 110 configured as described above can be formed using an appropriate metal member, such as stainless steel or aluminum, having excellent strength and durability, for example. However, a material for forming the top holder 110 is not particularly limited. Also, for the shape of the top holder 110, the above aspect is an example and other shapes may be adopted.

### Bottom Container

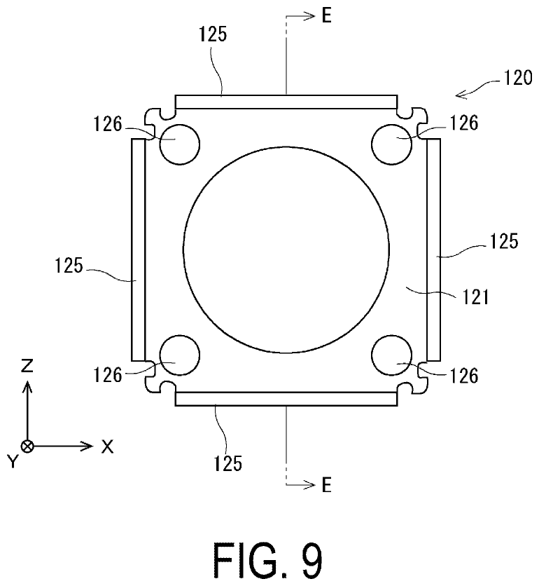

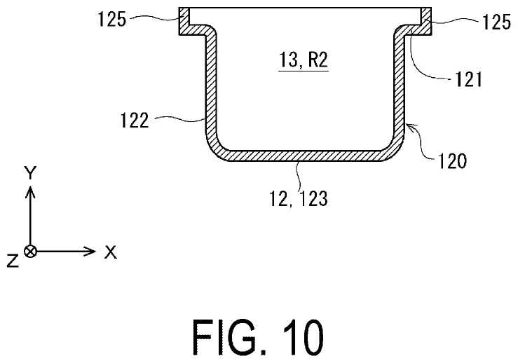

Next, the bottom container 120 will be described. FIG. 9 is a top view of the bottom container 120, and FIG. 10 is a vertical cross-sectional view of the bottom container 120 taken along line E-E illustrated in FIG. 9. The bottom container 120 has a substantially tubular bottomed shape with a hollow inside, and includes a side wall portion (peripheral wall) 122, a bottom wall portion 123 connected to a lower end of the side wall portion 122, and the flange portion 121 connected to an upper end of the side wall portion 122. The side wall portion 122 has, for example, a cylindrical tubular shape. The flange portion 121 extends outward from the upper end of the side wall portion 122, that is, from a contact portion with the lower housing body 140. The contour of the flange portion 121 in the bottom container 120 has a substantially quadrangular shape that fits inside the lower tubular wall 104 in the housing body 100. A bolt passing hole 126 is provided passing through the flange portion 121 in the vertical direction. A fastening bolt is made to pass through the bolt passing hole 126. The four edges of the flange portion 121 are each provided with the rib portion 125 extended toward the conductor piece 50 side along the extending direction (Y direction) of the accommodating space. The rib portion 125 has a flat plate shape formed longitudinally along the outer edge of the flange portion 121. The rib portion 125 can be formed by bending each of the four sides of the flange portion 121 downward. The size of the rib portion 125 is not particularly limited. For example, the length thereof along an outer edge of the flange portion 121 (hereinafter also referred to as a “rib length”) may be 10 mm to 30 mm, and the length thereof protruding upward from the upper surface of the flange portion 121 (hereinafter also referred to as a “rib height”) may be 1 mm to 10 mm.

Note that the above aspect regarding the shape of the bottom container 120 is an example, and other shapes may be adopted. The cavity portion (internal space) formed inside the bottom container 120 communicates with the housing body 100 located on the upper side, and forms a portion of the accommodating space 13. The bottom container 120 configured as described above can be formed using an appropriate metal member, such as stainless steel or aluminum, having excellent strength and durability, for example. However, a material for forming the bottom container 120 is not particularly limited. Further, the bottom container 120 may have a multilayer structure. For example, in the bottom container 120, an exterior portion facing the outside may be formed using an appropriate metal member, such as stainless steel or aluminum, having excellent strength and durability, and an interior portion facing the accommodating space 13 may be formed using an insulating member such as a synthetic resin. Of course, the entire bottom container 120 may be formed using an insulating member.

As described above, the housing 10 in the present embodiment is configured by vertically integrally assembling the top holder 110, the upper housing body 130, the lower housing body 140, and the bottom container 120. In the process of this assembly, the conductor piece 50 is disposed through the inside of the housing body 100. For example, the conductor piece 50 is fitted into a conductor piece holding portion 144 of the lower housing body 140, and the conductor piece is disposed crossing the cavity portion 145. The lower surface of the upper housing body 130 abuts against the upper surface of the lower housing body 140 and thus the bolt passing hole 142 of the lower housing body 140 and the bolt passing hole 132 of the upper housing become coaxial in this state. Furthermore, the flange portion 111 of the top holder 110 is inserted inside the upper tubular wall 103 of the upper housing body 130 to dispose the top holder 110 on the upper housing body 130, and the flange portion 121 of the bottom container 120 is inserted inside the lower tubular wall 104 of the lower housing body 140 to dispose the bottom container 120 under the lower housing body 140. Then, bolts are passed through the bolt passing holes of the top holder 110, the upper housing body 130, the lower housing body 140, and the bottom container 120 to fasten the respective portions. Note that the bolt is not necessarily used for the fastening, and the fastening may be performed with other fastening means such as a rivet.

Each portion may be bonded in a state where a sealant is applied between the top holder 110 and the upper housing body 130, between the upper housing body 130 and each of the lower housing body 140 and the conductor piece 50, between the lower housing body 140 and the conductor piece 50, and between the lower housing body 140 and the bottom container 120. This can increase airtightness of the accommodating space 13 formed in the housing 10. The airtightness of the accommodating space 13 may be enhanced by interposing a packing or a gasket between the portions in place of the sealant or in combination with the sealant. This accommodating space 13 accommodates the igniter 20, the projectile 40, a cutoff portion 53 of the conductor piece 50, the coolant material 60, and the like described in detail below.

### Igniter

Next, the igniter 20 will be described. The igniter 20 is an electric igniter that includes an ignition portion 21 with an ignition charge, and an igniter body 22 including a pair of electro-conductive pins (not illustrated) connected to the ignition portion 21. The igniter body 22 is surrounded by an insulating resin, for example. Further, tip end sides of the pair of electro-conductive pins in the igniter body 22 are exposed to the outside, and are connected to a power source when the breaker device 1 is used.

The igniter body 22 includes a body portion 221 having a substantially circular columnar shape and accommodated inside the small diameter cylinder portion 112 in the top holder 110, and a connector portion 222 positioned on the body portion 221. The igniter body 22 is fixed to the small diameter cylinder portion 112 by, for example, the body portion 221 being pressed to an inner circumferential surface of the small diameter cylinder portion 112. Further, a constricted portion having an outer circumferential surface recessed as compared with other locations is annularly formed along a circumferential direction of the body portion 221 at an axially intermediate portion of the body portion 221. An O-ring 223 is fitted into this constricted portion. The O-ring 223 is formed of, for example, rubber (silicone rubber, for example) or a synthetic resin, and functions to increase airtightness between the inner circumferential surface in the small diameter cylinder portion 112 and the body portion 221.

The connector portion 222 in the igniter 20 is disposed protruding to the outside through an opening 112A formed at an upper end of the small diameter cylinder portion 112. The connector portion 222 has, for example, a cylindrical tubular shape covering sides of the electro-conductive pins, allowing connection with a connector of a power source.

As illustrated in FIG. 1, the ignition portion 21 of the igniter 20 is disposed facing the accommodating space 13 (more specifically, the cavity portion formed inside the large diameter cylinder portion 113) of the housing 10. The ignition portion 21 is configured as a form accommodating an ignition charge in an igniter cup, for example. For example, the ignition charge is accommodated in the igniter cup in the ignition portion 21 in a state of being in contact with a bridge wire (resistor) suspended coupling the base ends of the pair of electro-conductive pins to each other. As the ignition charge, for example, zirconium-potassium perchlorate (ZPP), zirconium-tungsten-potassium perchlorate (ZWPP), titanium hydride-potassium perchlorate (THPP), lead tricinate, or the like may be adopted.

In actuation of the igniter 20, when an actuating current for igniting the ignition charge is supplied from the power source to the electro-conductive pins, the bridge wire in the ignition portion 21 generates heat, and as a result, the ignition charge in the igniter cup is ignited and burns, generating a combustion gas. Then, the pressure in the igniter cup increases along with the combustion of the ignition charge in the igniter cup of the ignition portion 21, a rupture surface 21A of the igniter cup ruptures, and the combustion gas is discharged from the igniter cup into the accommodating space 13. More specifically, the combustion gas from the igniter cup is discharged into a recess 411 in a piston portion 41 described later of the projectile 40 disposed in the accommodating space 13.

### Projectile

Next, the projectile 40 will be described. The projectile 40 is formed using an insulating member such as a synthetic resin, for example, and includes the piston portion 41 and a rod portion 42 connected to the piston portion 41. The piston portion 41 has a substantially circular columnar shape and has an outer diameter substantially corresponding to an inner diameter of the large diameter cylinder portion 113 in the top holder 110. For example, the diameter of the piston portion 41 may be slightly smaller than the inner diameter of the large diameter cylinder portion 113. The shape of the projectile 40 can be changed as appropriate according to the shape of the housing 10 and the like.

Further, the recess 411 having a circular columnar shape, for example, is formed in an upper surface of the piston portion 41. This recess 411 receives the ignition portion 21. A bottom surface of the recess 411 is formed as a pressure receiving surface 411A that receives energy received from the igniter 20 during actuation of the igniter 20. Further, a constricted portion having an outer circumferential surface recessed as compared with other locations is annularly formed along a circumferential direction of the piston portion 41 at an axially intermediate portion of the piston portion 41. An O-ring 43 is fitted into this constricted portion. The O-ring 43 is formed of, for example, rubber (silicone rubber, for example) or a synthetic resin, and functions to increase airtightness between an inner circumferential surface in the large diameter cylinder portion 113 and the piston portion 41.

The rod portion 42 of the projectile 40 is a rod-shaped member having an outer circumferential surface smaller in diameter than the piston portion 41, for example, and is integrally connected to a lower end side of the piston portion 41. A lower end surface of the rod portion 42 is formed as a cutoff surface 420 for cutting off the cutoff portion 53 from the conductor piece 50 during actuation of the breaker device 1. Note that although the rod portion 42 in the present embodiment has a substantially cylindrical tubular shape, the shape thereof is not particularly limited, and can be changed in accordance with the shape and size of the cutoff portion 53 to be cut off from the conductor piece 50 during actuation of the breaker device 1. The rod portion 42 may have a columnar shape such as a circular column or a rectangular column, for example. Note that at the initial position of the projectile 40 illustrated in FIG. 1, a region on the tip end side including the cutoff surface 420 in the rod portion 42 of the projectile 40 is positioned in a cavity portion (forming a portion of the accommodating space 13) of the housing body 100. The diameter of the rod portion 42 is slightly smaller than the inner diameter of an inner circumferential surface of the housing body 100, for example, and the outer circumferential surface of the rod portion 42 is guided along the inner circumferential surface when the projectile 40 is projected.

As described in detail later, the projectile 40 configured as described above is projected from the initial position illustrated in FIG. 1 when the upper surface of the piston portion 41 including the pressure receiving surface 411A receives the energy from the igniter 20 during actuation of the igniter 20, and moves at high speed toward the second end portion 12 side (downward) along the accommodating space 13. Specifically, as illustrated in FIG. 1, the piston portion 41 of the projectile 40 is accommodated inside the large diameter cylinder portion 113 in the top holder 110, and is slidable in the axial direction along an inner wall surface of the large diameter cylinder portion 113. In the present embodiment, the piston portion 41 of the projectile 40 has a substantially circular columnar shape, but the shape thereof is not particularly limited. As the outer shape of the piston portion 41, an appropriate shape and size can be adopted in accordance with the shape and size of the inner wall surface of the large diameter cylinder portion 113.

### Conductor Piece

Next, the conductor piece 50 will be described. As illustrated in FIG. 2, the conductor piece 50 is fitted into the conductor piece holding portions 144 of the lower housing body 140 and is disposed crossing the accommodating space 13. The conductor piece 50 is a metal body having conductivity that constitutes a portion of the components of the breaker device 1 and, when the breaker device 1 is attached to a predetermined electric circuit, forms a portion of the electric circuit, and may be referred to as a bus bar. The conductor piece 50 can be formed using a metal such as copper (Cu), for example. However, the conductor piece 50 may be formed using a metal other than copper, or may be formed using an alloy of copper and another metal. Note that examples of metals other than copper included in the conductor piece 50 include manganese (Mn), nickel (Ni), and platinum (Pt).

In one aspect illustrated in FIG. 2, the conductor piece 50 is formed as an elongated flat plate piece as a whole, and includes a first connection end portion 51 and a second connection end portion 52 on both end sides, and the cutoff portion 53 positioned in an intermediate portion thereof. The first connection end portion 51 and the second connection end portion 52 of the conductor piece 50 are provided with connection holes 51A and 52A, respectively. These connection holes 51A, 52A are used to connect with other conductors (lead wires, for example) in the electric circuit. Note that in FIG. 1, the connection holes 51A and 52A in the conductor piece 50 are not illustrated. The cutoff portion 53 of the conductor piece 50 is a site that is forcibly and physically cut by the rod portion 42 of the projectile 40 and cut off from the first connection end portion 51 and the second connection end portion 52 when an abnormality such as an excessive current occurs in the electric circuit to which the breaker device 1 is applied. Notches (slits) 54 are formed at both ends of the cutoff portion 53 of the conductor piece 50, making it easy to cut and cut off the cutoff portion 53.

The conductor piece 50 is cut at a position overlapping the inside surface (inner wall surface) of an inner wall 143 defining the cavity portion 145 of the housing body 100, that is, a position overlapping the outer circumferential surface of the rod portion 42, and thus the cutoff portion 53 is cut off. In the first connection end portion 51 of the conductor piece 50, a boundary portion with the cutoff portion 53 from which the cutoff portion 53 is cut off is defined as a first cutting edge portion 511, and in the second connection end portion 52, a boundary portion with the cutoff portion 53 from which the cutoff portion 53 is cut off is defined as a second cutting edge portion 521.

Here, various forms of the conductor piece 50 can be adopted, and a shape thereof is not particularly limited. In the example illustrated in FIG. 2, the surfaces of the first connection end portion 51, the second connection end portion 52, and the cutoff portion 53 form the same plane, but the present invention is not limited to this. For example, in the conductor piece 50, the cutoff portion 53 may be connected to the first connection end portion 51 and the second connection end portion 52 in an orientation where the cutoff portion 53 is orthogonal or inclined with respect to the first connection end portion 51 and the second connection end portion 52. Further, the planar shape of the cutoff portion 53 of the conductor piece 50 is not particularly limited, either. Of course, the shapes of the first connection end portion 51 and the second connection end portion 52 in the conductor piece 50 are also not particularly limited. Further, the notches 54 in the conductor piece 50 can be omitted as appropriate.

### Coolant Material

Next, the coolant material 60 disposed in the accommodating space 13 in the housing 10 will be described. As illustrated in FIG. 1, prior to actuation of the breaker device 1 (igniter 20), the cutoff portion 53 of the conductor piece 50 in a state of being held in the housing body 100 is horizontally laid crossing the accommodating space 13 of the housing 10. Hereinafter, within the accommodating space 13 of the housing 10 separated by the cutoff portion 53 of the conductor piece 50, a region (space) in which the projectile 40 is disposed is referred to as a “projectile initial arrangement region R1”, and a region (space) positioned on the opposite side to the projectile 40 is referred to as an “arc-extinguishing region R2”. Note that as described above, since a gap is formed on the side of the cutoff portion 53 disposed crossing the accommodating space 13, the projectile initial arrangement region R1 and the arc-extinguishing region R2 are not completely isolated from each other by the cutoff portion 53 but communicate with each other. Of course, depending on the shape and size of the cutoff portion 53, the projectile initial arrangement region R1 and the arc-extinguishing region R2 may be completely isolated from each other by the cutoff portion 53.

The arc-extinguishing region R2 of the accommodating space 13 is a region (space) for receiving the cutoff portion 53 cut off by the rod portion 42 of the projectile 40 projected during actuation of the breaker device 1 (igniter 20). In this arc-extinguishing region R2, the coolant material 60 as an arc-extinguishing material is disposed. The coolant material 60 is a coolant material for removing thermal energy of the arc generated and the cutoff portion 53 when the projectile 40 cuts off the cutoff portion 53 of the conductor piece 50, and cooling the arc and the cutoff portion 53, thereby suppressing arc generation during cutting off of a current or thereby extinguishing (eliminating) the generated arc.

The arc-extinguishing region R2 in the breaker device 1 is a space for receiving the cutoff portion 53 cut off from the first connection end portion 51 and the second connection end portion 52 of the conductor piece 50 by the projectile 40, and at the same time, has a meaning as a space for effectively extinguishing an arc generated when the projectile 40 cuts off the cutoff portion 53. Then, to effectively extinguish the arc generated when the cutoff portion 53 is cut off from the conductor piece 50, the coolant material 60 is disposed as an arc-extinguishing material in the arc-extinguishing region R2.

As one aspect of the embodiment, the coolant material 60 is solid. As one aspect of the embodiment, the coolant material 60 is formed of a shape retaining body. The shape retaining body herein is, for example, a material that can keep a constant shape when no external force is applied and can hold the integrity (does not come apart), even if deformation can occur, when an external force is applied. For example, examples of the shape retaining body include a fibrous body formed into a desired shape. In the present embodiment, the coolant material 60 is formed of a metal fiber that is a shape retaining body. Here, examples of the metal fiber forming the coolant material 60 include an aspect in which at least any one of steel wool or copper wool is included. However, the above aspects in the coolant material 60 are examples, and the coolant material 60 is not limited to the above aspects.

The coolant material 60 is formed into a substantially disk shape, for example, and is disposed at a bottom portion of the bottom container 120.

### Operation

Next, operation content when the breaker device 1 is actuated to interrupt the electric circuit will be described. As described above, FIG. 1 illustrates a state of the breaker device 1 prior to actuation (hereinafter also referred to as the “pre-actuation initial state”). In this pre-actuation initial state, in the projectile 40 in the breaker device 1, the piston portion 41 is positioned on the first end portion 11 side (upper end side) in the accommodating space 13, and the cutoff surface 420 formed at the lower end of the rod portion 42 is set at an initial position positioned on the upper surface of the cutoff portion 53 in the conductor piece 50.

Furthermore, the breaker device 1 according to the embodiment further includes an abnormality detection sensor (not illustrated) that detects an abnormal state of a device (such as a vehicle, a power generation facility, or a power storage facility) to which an electric circuit to be cut off is connected, and a control unit (not illustrated) that controls the actuation of the igniter 20. The abnormality detection sensor may be capable of detecting an abnormal state on the basis of a voltage or a temperature of the conductor piece 50 in addition to the current flowing through the conductor piece 50. Further, the abnormality detection sensor may be, for example, an impact sensor, a temperature sensor, an acceleration sensor, a vibration sensor, or the like, and may detect an abnormal state such as an accident or fire on the basis of an impact, a temperature, acceleration, or vibration in a device such as a vehicle. The control unit of the breaker device 1 is a computer capable of performing a predetermined function by executing a predetermined control program, for example. The predetermined function of the control unit may be achieved by corresponding hardware. Then, when excessive current flows through the conductor piece 50 forming a portion of the electric circuit to which the breaker device 1 is applied, the abnormal current is detected by the abnormality detection sensor. Abnormality information regarding the detected abnormal current is passed from the abnormality detection sensor to the control unit. For example, the control unit is energized from an external power source (not illustrated) connected to the electro-conductive pins of the igniter 20 and actuates the igniter 20, based on the current value detected by the abnormality detection sensor. Here, the abnormal current may be a current value that exceeds a predetermined threshold value set for protection of a predetermined electric circuit. Note that the abnormality detection sensor and the control unit described above need not be included in the constituent elements of the breaker device 1, and may be included in a device separate from the breaker device 1, for example. Further, the abnormality detection sensor and the control unit are not essential components of the breaker device 1.

For example, when an abnormal current of the electric circuit is detected by an abnormality detection sensor that detects an abnormal current of the electric circuit, the control unit of the breaker device 1 actuates the igniter 20. That is, an actuating current is supplied from the external power source (not illustrated) to the electro-conductive pins of the igniter 20, and as a result, the ignition charge in the ignition portion 21 is ignited and burns, generating a combustion gas. Then, the rupture surface 21A ruptures due to rise in pressure in the ignition portion 21, and the combustion gas of the ignition charge is discharged from the inside of the ignition portion 21 into the accommodating space 13.

Here, the ignition portion 21 of the igniter 20 is received in the recess 411 of the piston portion 41, and the rupture surface 21A of the ignition portion 21 is disposed facing the pressure receiving surface 411A of the recess 411 in the projectile 40. Therefore, the combustion gas from the ignition portion 21 is discharged to the recess 411, and the pressure (combustion energy) of the combustion gas is transmitted to the upper surface of the piston portion 41 including the pressure receiving surface 411A. As a result, the projectile 40 moves downward in the accommodating space 13 in the extending direction (axial direction) of the accommodating space 13.

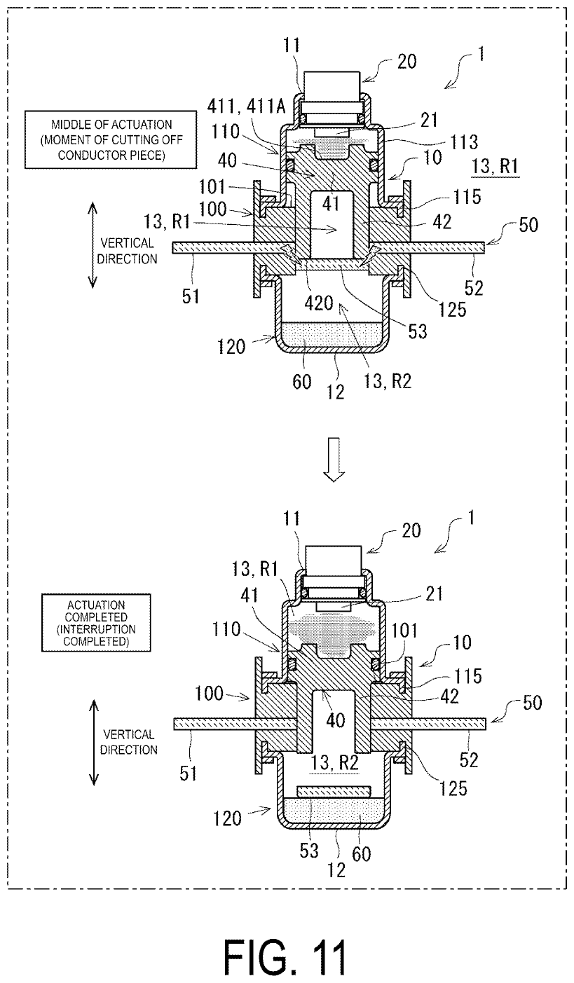

FIG. 11 is a diagram illustrating an actuation situation of the breaker device 1 according to the embodiment. The upper stage of FIG. 11 illustrates a situation in the middle of the actuation of the breaker device 1, and the lower stage of FIG. 11 illustrates a situation in which the actuation of the breaker device 1 is completed. As described above, by the actuation of the igniter 20, the projectile 40 having received the pressure (combustion energy) of the combustion gas of the ignition charge is pushed downward vigorously, and as a result, the cutoff surface 420 formed on the lower end side of the rod portion 42 pushes and cuts, by shearing, boundary portions between the cutoff portion 53 and each of the first connection end portion 51 and the second connection end portion 52 of the conductor piece 50. As a result, the cutoff portion 53 is cut off from the conductor piece 50. Note that as long as the projectile 40 can be moved smoothly in the extending direction (axial direction) of the accommodating space 13 when the igniter 20 is actuated, the shape and the dimensions of the projectile 40 can be freely determined, and the outer diameter of the piston portion 41 of the projectile 40 may be set to a dimension equal to the inner diameter of the large diameter cylinder portion 113 in the top holder 110, for example.

Then, as illustrated in the lower stage of FIG. 11, the projectile 40 moves downward along the extending direction (axial direction) of the accommodating space 13 by a predetermined stroke until the lower end surface of the piston portion 41 is brought into contact with (collides with) the upper surface 101 of the housing body 100. In this state, the cutoff portion 53 cut off from the conductor piece 50 by the rod portion 42 of the projectile 40 is received in the arc-extinguishing region R2 where the coolant material 60 is disposed. As a result, the first connection end portion 51 and the second connection end portion 52 positioned at both ends of the conductor piece 50 are brought into an electrically disconnected state, and a predetermined electric circuit to which the breaker device 1 is applied is forcibly interrupted.

### Variation of Rib Portions

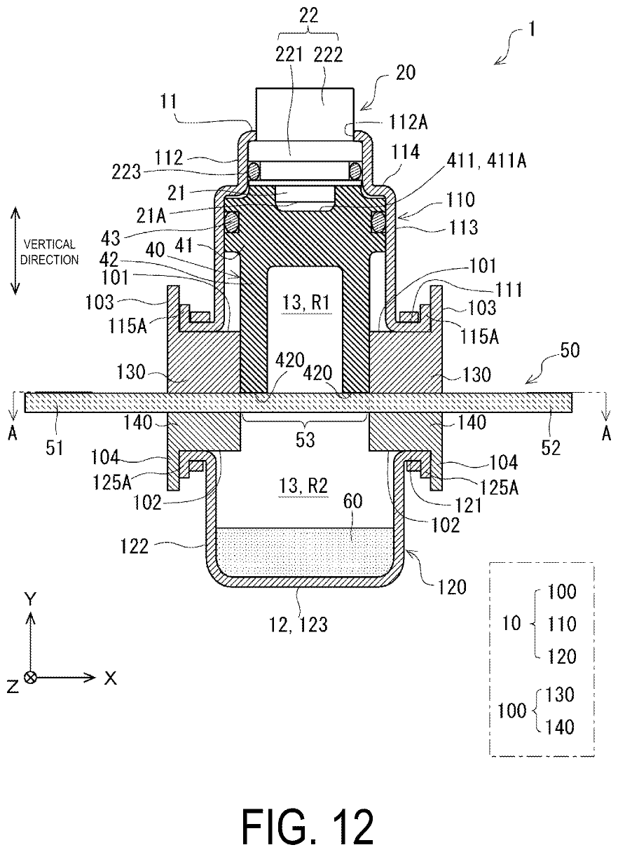

In the above-described embodiment, the example is given in which the rib portions 115 and 125 extend from the edges of the flange portions 111 and 121, respectively, toward the conductor piece side along the extending direction of the accommodating space 13. However, the rib portions are not limited to the above configuration, and may be extended toward the opposite side to the conductor piece. FIG. 12 is a diagram illustrating a variation of rib portions 115A and 125A. In the present variation, the rib portion (top-side rib portion) 115A is extended from the outer side edge of the top-side flange portion 111 toward the opposite side to the conductor piece 50 along the extending direction of the accommodating space 13. Therefore, in the present variation, the groove portion 131, into which the rib portion is fitted, is not provided in the upper surface 101 of the upper housing body 130.

The rib portion (bottom-side rib portion) 125A is extended from the outer side edge of the bottom-side flange portion 121 toward the opposite side to the conductor piece 50 along the extending direction of the accommodating space 13. Therefore, in the present variation, the groove portion 141, into which the rib portion is fitted, is not provided in the lower surface 102 of the lower housing body 140. Other configurations are the same as those of the above-described embodiment.

### Advantages

As described above, when the breaker device 1 is actuated, the ignition charge in the ignition portion 21 is ignited and burns, and the combustion gas is discharged into the accommodating space 13, whereby the pressure in the accommodating space 13 increases. At this time, when the flange portions 111 and 121 of the top holder 110 and the bottom container 120, respectively, which are contact portions with the housing body 100, are distorted, a gap is formed between the housing body 100 and each of the top holder 110 and the bottom container 120, and the combustion gas may leak out. For this reason, in the present embodiment, the rib portions 115 and 125 are provided at the edges of the flange portions 111 and 121, respectively, to reinforce the flange portions 111 and 121, thereby suppressing the distortion of the flange portions 111 and 121. As a result, the breaker device 1 of the present embodiment can prevent the leakage of the combustion gas and improve the reliability.

For example, Table 1 shows comparison of the magnitude of distortion after actuation between the breaker device 1 of the present embodiment and a comparative example. In Table 1, samples No. 3 and No. 4 are each a case of the breaker device 1 of the present embodiment. In sample No. 3, the rib length of the rib portion 115 of the top holder 110 is 27 mm, the rib height of the rib portion 115 is 3 mm, and the interval between the bolt passing holes through which the fastening bolts are made to pass (hereinafter referred to as a hole interval) is 27.5 mm. In this case, the distortion of the flange portion 111 in the Y direction was 0.054 mm. In sample No. 4, the rib length of the top holder 110 is 20 mm, the rib height is 3 mm, and the hole interval is 30 mm. In this case, the distortion of the flange portion 111 in the Y direction was 0.151 mm.

On the other hand, sample No. 1 is a case of a breaker device in the related art in which no rib portion is provided, and the hole interval of the top holder is 30 mm. In this case, the distortion of the flange portion in the Y direction was 0.492 mm.

Sample No. 2 is a case of the variation (FIG. 12) in which the rib portion 115A facing upward is provided at the edge of the flange portion 111, that is, the rib portion 115A is formed facing the opposite side in the Y direction as compared to samples No. 3 and No. 4. In sample No. 2, the length of the rib portion facing upward of the top holder is 27 mm, the height of the rib portion is 6 mm, and the hole interval is 27.5 mm. In this case, the distortion of the flange portion in the Y direction was 0.231 mm.

TABLE 1

| Sample | | |
|---|---|---|
| No. | Conditions | Distortion |
| 1 | No rib portion, hole interval: 30 mm | 0.492 |
| 2 | Rib portion facing upward, hole interval: 27.5 mm | 0.231 |
| | Rib height: 6 mm, rib length 27 mm | |
| 3 | Rib portion facing downward, hole interval: 27.5 mm | 0.054 |
| | Rib height: 6 mm, rib length 27 mm | |
| 4 | Rib portion facing downward, hole interval: 27.5 mm | 0.151 |
| | Rib height: 6 mm, rib length 27 mm | |

As described above, when the rib portion is not provided in the flange portion, the distortion of the flange portion was largest. In the case where the rib portion 115A is provided facing upward (No. 2), the distortion was smaller than that of the case where no rib portion is provided, and larger than those of samples No. 3 and No. 4. The following can be suggested from the above results. In the top holder, when the rib portion 115A facing upward is provided, the pressure at the time of actuation acts in a direction of expanding the rib portion 115A, whereas when the rib portion 115 facing downward is provided as in samples No. 3 and No. 4, the pressure at the time of actuation acts in a direction of contracting the rib portion 115. Accordingly, the rib portion 115 facing downward can presumably suppress the distortion of the flange portion 111 more effectively. Similarly, also in the bottom container 120, it can be suggested that the rib portion 125 facing upward can suppress the distortion of the flange portion 121 more effectively than the rib portion formed facing downward from the flange portion 121. As described above, according to the present embodiment and the variation, it is possible to suppress the distortion of the flange portion and improve the reliability of the breaker device 1. As illustrated in FIGS. 1 to 10, when the rib portions 115 and 125 are provided extending toward the conductor piece 50 side, it is possible to effectively suppress the distortion of the flange portions 111 and 121 and further improve the reliability of the breaker device 1.

While the embodiment of the electric circuit breaker device according to the present disclosure has been described above, each of the aspects disclosed in the present specification can be combined with any other feature disclosed in the present specification.

### REFERENCE SIGNS LIST

1 Breaker device
10 Housing
100 Housing body
101 Upper surface
102 Lower surface
103 Upper tubular wall
104 Lower tubular wall
110 Top holder
111 Flange portion
112 Small diameter cylinder portion
112A Opening
113 Large diameter cylinder portion
114 Connection portion
115, 115A Rib portion
120 Bottom container
121 Flange portion
122 Side wall portion
123 Bottom wall portion
125, 125A Rib portion
13 Accommodating space
130 Upper housing body
131 Groove portion
135 Cavity portion
140 Lower housing body
141 Groove portion
143 Inner wall
144 Conductor piece holding portion
145 Cavity portion
20 Igniter
40 Projectile
41 Piston portion
411A Pressure receiving surface
42 Rod portion
420 Cutoff surface
43 Ring
50 Conductor piece
60 Coolant material

1. An electric circuit breaker device comprising:
a housing, as an outer shell member, that encloses an accommodating space extending in one direction;
an igniter provided in the housing;
a projectile disposed in the housing and being configured to be projected from one end side of the accommodating space by energy received from the igniter and move along an extending direction of the accommodating space; and
a conductor piece provided in the housing and forming a portion of an electric circuit, the conductor piece including, in part of the conductor piece, a cutoff portion that is disposed crossing the accommodating space and is to be cut off by the projectile, wherein
the housing includes a housing body that holds the conductor piece and a top housing portion provided with the igniter,
the housing body includes the accommodating space passing through the housing body from a first surface on a side of the igniter to a second surface located on a side opposite to the first surface,
the top housing portion forms, by the top housing portion being attached while being in contact with the first surface of the housing body, an internal space communicating with the accommodating space inside the housing body and forming a portion of the accommodating space that accommodates the projectile before being projected, and
the top housing portion includes
a peripheral wall that defines an outer periphery of the accommodating space and is provided along the extending direction of the accommodating space,
a top-side flange portion extended from a contact portion of the peripheral wall with the first surface toward an outer side of the top housing portion along the first surface, and
a top-side rib portion extended along the extending direction from an outer side edge of the top-side flange portion.

2. The electric circuit breaker device according to claim 1, wherein the top-side rib portion is extended from the outer side edge of the top-side flange portion toward a side of the conductor piece along the extending direction.

3. The electric circuit breaker device according to claim 2, wherein the first surface of the housing body is provided with a groove portion into which the top-side rib portion of the top housing portion is fitted.

4. The electric circuit breaker device according to claim 1, wherein the top-side rib portion is extended from the outer side edge of the top-side flange portion toward a side opposite to the conductor piece along the extending direction.

5. The electric circuit breaker device according to claim 1, wherein
the housing further includes a bottom housing portion being attached while being in contact with the second surface, and including an internal space that communicates with the accommodating space inside the housing body and forms a portion of the accommodating space in which the cutoff portion is to be received after being cut off, and
the bottom housing portion includes
a peripheral wall that defines an outer periphery of the accommodating space and is provided along the extending direction of the accommodating space,
a bottom-side flange portion extended from a contact portion of the peripheral wall with the second surface toward an outer side of the bottom housing portion along the second surface, and
a bottom-side rib portion extended from an outer side edge of the bottom housing portion toward the side of the conductor piece along the extending direction.

6. The electric circuit breaker device according to claim 5, wherein the second surface of the housing body is provided with a groove portion into which the bottom-side rib portion of the bottom housing portion is fitted.

7. The electric circuit breaker device according to claim 1, wherein
the housing further includes a bottom housing portion being attached while being in contact with the second surface, and including an internal space that communicates with the accommodating space inside the housing body and forms a portion of the accommodating space in which the cutoff portion is to be received after being cut off, and
the bottom housing portion includes
a peripheral wall that defines an outer periphery of the accommodating space and is provided along the extending direction of the accommodating space,
a bottom-side flange portion extended from a contact portion of the peripheral wall with the second surface toward an outer side of the bottom housing portion along the second surface, and
a bottom-side rib portion extended from an outer side edge of the bottom housing portion toward a side opposite to the conductor piece along the extending direction.
